(19) United States
(12) Patent Application Publication
(10) Pub. No.: US 2026/0135725 A1
(43) Pub. Date: May 14, 2026

(54) ENABLING TIMER-BASED METERING OF NETWORK RESOURCES UTILIZED BY AN AMD

(71) Applicant: T-MOBILE INNOVATIONS LLC, Overland Park, KS (US)

(72) Inventors: Suryaprakash Reddy Voodem, Bothell, WA (US); Yamuna Sai Mukkamala, Bellevue, WA (US); Ryan James McGinn, Shawnee, KS (US)

(21) Appl. No.: 18/945,275

(22) Filed: Nov. 12, 2024

(51) Int. Cl. H04L 12/14

(52) U.S. Cl. CPC H04L 12/1439; H04L 12/1407

(57) ABSTRACT

Systems and methods are contemplated herein for initiating and/or enabling timer-based metering of network resources utilized by an access management device (AMD). The method may include one or more network functions (NFs) and/or one or more computer processing components receiving an indication to initiate timer-based metering of network resources utilized by the AMD. In some aspects, the indication indicates the AMD is outside of a home area associated with the AMD. The method may include initiating and/or enabling the timer-based metering of the network resources utilized by the AMD by the one or more NFs and/or the one or more computer processing components.

### SUMMARY

The present disclosure is directed, in part, to systems and methods for providing timer-based metering of network resources, substantially as shown and/or described in connection with at least one of the figures, and as set forth more completely in the claims.

According to various aspects of the technology, systems and methods enabling a flexible approach to providing timer-based metering of network resources utilized by an access management device (AMD) (e.g., a fixed wireless access (FWA) device, high-speed internet (HINT) device, a router, a hotspot) are provided. Many subscribers who access network resources do so using AMDs. Subscribers of home internet (HI) services (e.g., Wi-Fi services) are often limited in where they may access the internet under conventional HI subscriptions. Further, some subscribers may wish to have a backup HI subscription to utilize when the subscriber’s primary HI service is unavailable. Systems and methods are provided for enabling timer-based metering within a network. Timer-based metering of network resources may enable an AMD (e.g., devices accessing the network via the AMD) to use data as measured by a duration of time. One or more network functions (NFs) within the network may receive an indication to initiate timer-based metering of network resources utilized by the AMD. One or more NFs and/or computer processing components may initiate the timer-based metering of the network resources utilized by the AMD by modifying one or more data usage policies associated with the AMD and/or implementing one or more modified data usage policies associated with the AMD. The one or more NFs and/or computer processing components may monitor a duration of time the AMD utilizes the network resources. This solution provides a more flexible approach to managing network services.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates a flow diagram of exemplary network environment in which implementations of the present disclosure may be employed;

FIG. 4 illustrates a flow diagram of an exemplary method for enabling timer-based metering within a network in which implementations of the present disclosure may be employed; and

FIG. 5 illustrates a flow diagram of an exemplary method for enabling timer-based metering within a network in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be utilized by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, many subscribers who access network resources do so using home internet (HI) services. Subscribers of HI services are often limited in where they may access the internet using their HI subscription. For example, a HI subscriber may only access the internet using their HI subscription when an access management device (AMD) (e.g., a router, hotspot device) associated with the HI subscription is located at a home area (e.g., an address associated with the HI subscription or within a threshold distance from the address associated with the HI subscription). Further, some HI subscribers may wish to have a backup HI subscription to utilize when the subscriber’s primary HI service is unavailable.

Conventionally, HI subscription plans often center around a particular volume of data allotted per billing cycle, and the subscriber is billed a base cost even if the AMD did not use any network services or resources during the billing cycle. These volume-based HI subscription plans do not provide a cost-efficient fallback to a particular subscriber’s primary HI provider. For example, if the subscriber’s primary HI is working properly with no outages, the subscriber likely will not use a backup HI service, but the subscriber would still owe the base cost despite not needing backup coverage. Further, traditional HI subscription plans often require the subscriber be located at a home area in order to utilize the HI. For example, a HI subscriber may be leaving their home area in order to go on vacation, and has remaining data left from the data allotment. However, the HI subscriber is unable to use this remaining data on vacation. Present HI approaches lack flexibility in providing HI services outside of a home area and beyond traditional HI subscription plans.

In contrast to conventional solutions and to provide a flexible approach for subscribers to utilize HI, the present disclosure is directed to systems and methods for enabling timer-based metering within a network. Instead of traditional volume-based metering of network resources, the present disclosure provides a unique timer-based metering of network resources where an AMD may use data as measured by a duration of time. The AMD may be limited based on the duration of time where the AMD may utilize network resources, such that the AMD is allotted “up to 20 hours” of network utilization, as one example. One or more network functions (NFs) within the network may receive an indication to initiate timer-based metering of network resources utilized by an AMD. One or more NFs and/or computer processing components may initiate and/or enable the timer-based metering of the network resources utilized by the AMD by modifying one or more data usage policies associated with the AMD and/or implementing one or more modified data usage policies associated with the AMD. The one or more NFs may monitor and/or track a duration of time the AMD utilizes the network resources.

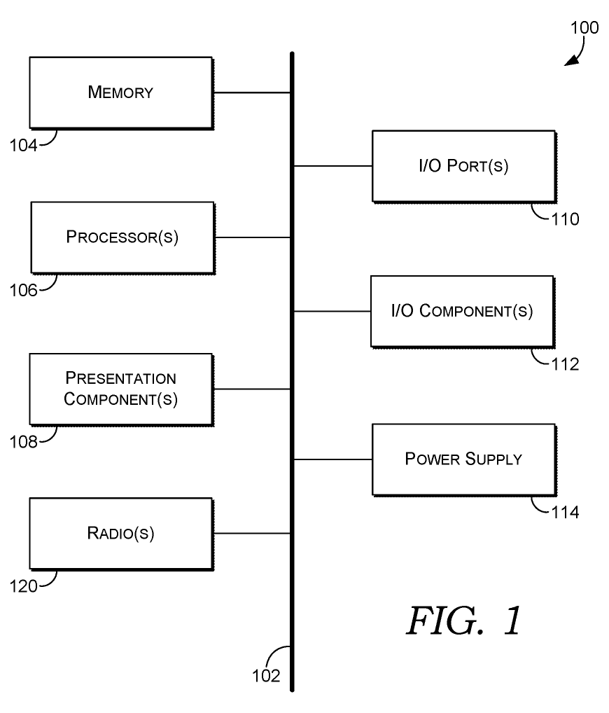

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), access management device (AMD), or user device. The computing device 100 may take many forms; non-limiting examples of the computing device 100 include an AMD (e.g., a fixed wireless access (FWA) device, router, hotspot, portable router), cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IoT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

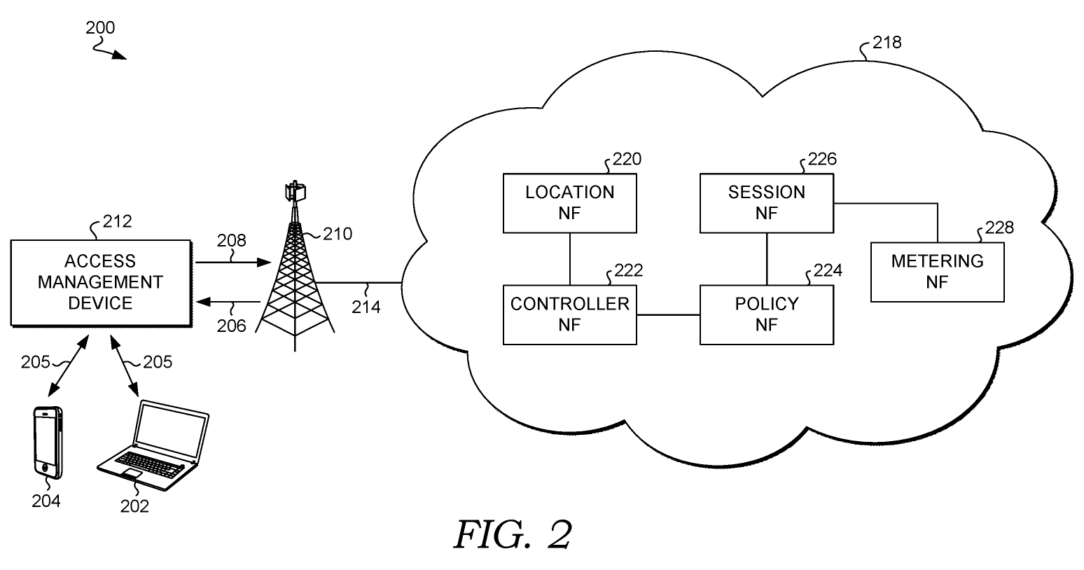

Referring now to FIG. 2, in a first embodiment of the present disclosure, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the present disclosure. Neither should the network environment 200 be interpreted as having any dependency or requirement relating to any one or combination of components illustrated.

Network environment 200 represents a high level and simplified view of relevant portions of one or more modern wireless telecommunication networks. At a high level, the network environment 200 may generally be said to comprise one or more UEs, such as a first UE 202 and/or a second UE 204, an access management device (AMD) 212, one or more base stations, such as a base station 210, and a core network 218, though in some implementations, it may not be necessary for certain features to be present. Similarly, while each component is shown in the singular, it is expressly contemplated that there may be more than one of the components described. For example, the network environment 200 may include additional base stations. The network environment 200 is generally configured for wirelessly connecting the first UE 202 and/or the second UE 204 to information and/or services that may be accessible on one or more application servers or other functions, nodes, or servers not pictured in FIG. 2 so as to not obscure the focus on the present disclosure.

The network environment 200 comprises the first UE 202 and/or the second UE 204. While illustrated as a smartphone and a laptop, the first UE 202 and/or the second UE 204 and may take any number of forms (e.g., tablet, wearable device, smart appliance), including any device discussed with respect to FIG. 1 and may have any one or more components or features of the computing device 100 of FIG. 1. The first UE 202 and/or the second UE 204 may communicate with one or more networks to request and/or receive information and/or services. The first UE 202 and/or the second UE 204 may connect to the AMD 212 to access network resources.

The network environment 200 comprises one or more access management devices (AMDs), such as the AMD 212. The AMD 212 may take various forms, such as a router, a portable router, a hotspot, a fixed wireless access (FWA) device, and the like. In some aspects, the AMD 212 may be a mobile hotspot (e.g., a phone or other UE shares its internet connection via Wi-Fi, Bluetooth, USB cable). The AMD 212 is configured to wirelessly communicate with various UEs, such as the first UE 202 and/or the second UE 204. In aspects, the AMD 212 may communicate with the first UE 202 and/or the second UE 204 using any telecommunication protocol desired by a network operator, including but not limited to, 802.11, 802.3, 802.15.1, 2G, 3G, 4G, 5G, 6G, and the like. The AMD 212 may communicate and/or receive signals to the first UE 202 and/or the second UE 204 via one or more transmissions 205. In response to receiving certain requests from the first UE 202 and/or the second UE 204, the AMD 212 may communicate with a base station (e.g., the base station 210) to access network resources (e.g., information, services). For example, the first UE 202 and/or the second UE 204 may wish to access streaming services (e.g., Netflix, Hulu) and the AMD 212 may forward the request to the base station 210. In this example, the base station 210 may send a response to the request to the AMD 212, and the AMD 212 may communicate the response to the first UE 202 and/or the second UE 204. The AMD 212 may be associated with a home area (e.g., a registered address of the AMD 212 and/or a HI subscription plan associated with the AMD 212 and/or a threshold distance from the registered address of the AMD 212). In aspects, the home area may originate from one or more care channels of an MNO associated with the AMD 212. The home area associated with the AMD 212 may be stored at a location network function (NF).

The network environment 200 comprises one or more base stations, such as the base station 210. Though network environment 200 is illustrated with one base station 210, one skilled in the art will appreciate that more base stations may be present in any particular network environment. The base station 210 of the network environment 200 is configured to wirelessly communicate with various UEs, such as the AMD 212. In aspects, the base station 210 may communicate with the AMD 212 using any wireless telecommunication protocol desired by a network operator, including but not limited to 2G, 3G, 4G, 5G, 6G, 802.11x, and the like. The base station 210 may communicate signals to the AMD 212 via a downlink 206 and receive signals from the AMD 212 via an uplink 208. In response to receiving certain requests from the AMD 212, for example, the base station 210 may communicate with the core network 218 via a backhaul 214. For example, in order for the AMD 212 to connect to a desired application server, the AMD 212 may communicate an attach request to the base station 210, which may, in response, communicate a registration request to the core network 218 via the backhaul 214.

The core network 218 may comprise one or more network functions (NFs). As used herein, the term “network function” is used to describe a computer processing module and/or one or more computer executable services being executed on one or more computing processing modules. NFs within the core network 218 are defined by their function, as the core network 218 is a service-based architecture. The core network 218 may comprise NFs that include any one or more of a location NF 220, a controller NF 222, a policy NF 224, a session NF 226, and a metering NF 228. Each of these NFs may communicate with each other, directly or indirectly, via interfaces existing between them using any one or more suitable protocols (e.g., diameter, HTTP/2). Each of the preceding NFs may take different forms, including consolidated or distributed forms that perform the same general operations. For example, the functions performed by the location NF 220 may be consolidated into the functions performed by the session NF 226. The NFs herein refer to functions, not specifically identified components. For example, the policy NF 224 may be a policy control function (PCF) or a policy and charging rules function (PCRF). In another example, the session NF 226 may be a session management function (SMF) or a mobility management entity (MME).

Though the location NF 220, the controller NF 222, the policy NF 224, the session NF 226, and the metering NF 228 are illustrated in the core network 218, the core network 218 may have more or fewer NFs than shown. Further, though the location NF 220, the controller NF 222, the policy NF 224, the session NF 226, and the metering NF 228 are illustrated as disposed within the core network 218, it is expressly contemplated that the location in the network environment 200 is non-limiting. For example, the NFs described above may be disposed between the base station 210 and the core network 218 (i.e., the network edge) or may be isolated as stand-alone components, or a combination of these. While each of the NFs described above are illustrated in the singular, it is expressly contemplated that the network environment 200 may include one or more of each of the NFs described above.

The location NF 220 may take a number of forms. The location NF 220 may take the form of a gateway mobile location center (GMLC), a visitor location register (VLR), a home subscriber server (HSS), a unified data management function (UDM), a location database (within one or more NFs), a mobility management entity (MME), an access and mobility management function (AMF), and the like. The location NF, for example, is generally responsible for managing and/or storing UE information, such as location information associated with the AMD 212. For example, when the AMD 212 attaches to the network, the AMD 212 may notify the network of its location, which may be received and/or stored by the location NF. In aspects, the location NF 220 may communicate with the controller NF 222, such as to provide location information (e.g., location information associated with the AMD 212).

The controller NF 222 may take a number of forms. In aspects, the controller NF 222 may take the form of a provisioning system, an access and mobility management function (AMF), a UDM, and the like. In other aspects, functions performed by the controller NF 222 may be performed by other NFs in the network environment 200. For example, the location NF may be a UDM, and the UDM may be configured to perform the functions of the controller NF 222. The controller NF 222, for example, is generally responsible for controlling and orchestrating actions within the network. For example, the controller NF may determine one or more service entitlements associated with the AMD (e.g., that the AMD is entitled to timer-based metering of network resources). In another example, the controller NF 222 may determine that one or more policies associated with a particular UE must be changed, and sends instructions to a policy NF (e.g., the policy NF 224) to modify the one or more policies.

The policy NF 224 may take a number of forms. The policy NF 224 may be a policy and control function (PCF), a policy and charging rules function (PCRF), a roaming policy function (RPF), and the like. The policy NF 224, for example, is generally responsible for managing and enforcing network policies (e.g., quality of service, access control, charging) based on subscriptions, application requirements, and network conditions. In aspects, the policy NF 224 communicates with the session NF 226, such as to provide and/or update one or more policies relevant to the session NF’s 226 establishment of sessions with AMDs (e.g., the AMD 212).

The session NF 226 may take many forms. The session NF 226 may be a session management function (SMF), a mobility management entity (MME), policy and charging enforcement function (PCEF), and the like. The session NF 226, for example, is generally responsible for managing the establishment, modification, and termination of sessions, as well as implementing and/or enforcing policies relevant to sessions. In aspects, the session NF 226 communicates with the metering NF 228, such as to implement and/or enforce one or more policies relevant to the metering NF 228.

The metering NF 228 may take a number of forms. The metering NF 228 may be a charging function (CHF), a usage monitoring function (UMF), and the like. The metering NF 228, for example, is generally responsible for collecting, processing, and managing charging data in real time, enabling accurate data consumption tracking and/or monitoring, as well as enforcing charging policies. In aspects, the metering NF 228 includes a timer function.

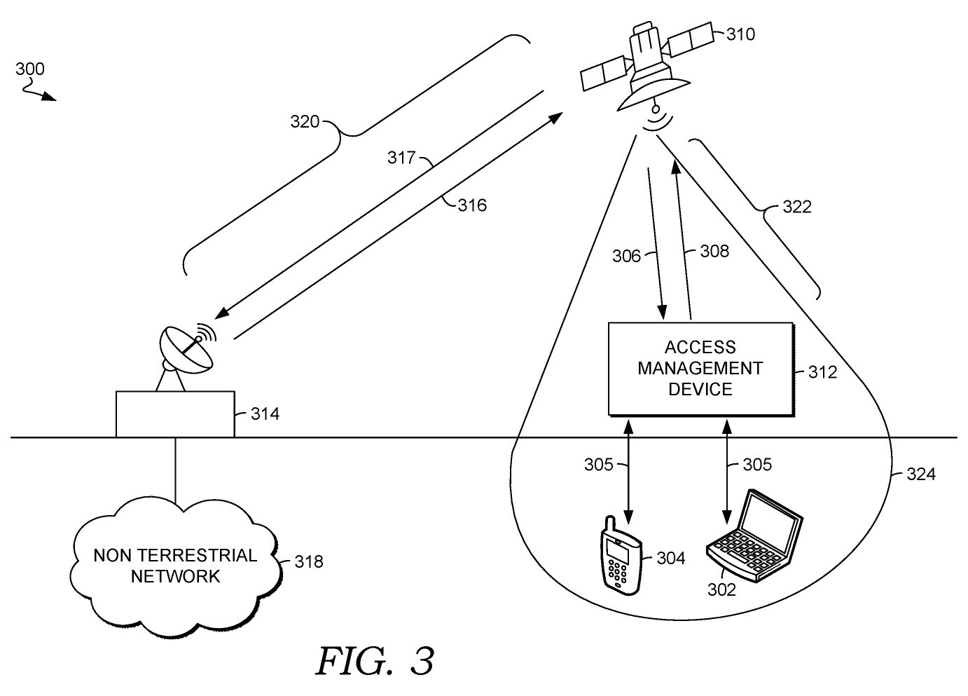

Referring now to FIG. 3, in a second embodiment of the present disclosure, an exemplary network environment is illustrated in which implementations of the present disclosure may be employed. Such a network environment is illustrated and designated generally as network environment 300. Network environment 300 is but one example of a suitable network environment and is not intended to suggest any limitation as to the scope of use or functionality of the present disclosure. Neither should the network environment 300 be interpreted as having any dependency or requirement relating to any one or combination of components illustrated. The network environment 300 may have any one or more aspects described with respect to the network environment 200.

Network environment 300 represents a high level and simplified view of relevant portions of one or more modern wireless telecommunication networks. At a high level, the network environment 300 may generally be said to comprise one or more UEs, such as a first UE 302 and/or a second UE 304 (e.g., the first UE 202 and/or the second UE 204 of FIG. 2), an access management device (AMD) 312 (e.g., the AMD 212 of FIG. 2), a non-terrestrial node 310, a gateway 314, and a non-terrestrial network (NTN) 318, though in some implementations, it may not be necessary for certain features to be present. Similarly, while each component is shown in the singular, it is expressly contemplated that there may be more than one of the components described. For example, the network environment 300 may include additional gateways and/or non-terrestrial nodes. The network environment 300 is generally configured for wirelessly connecting the first UE 302 and/or the second UE 304 to information and/or services that may be accessible on one or more application servers or other computer processing components, functions, nodes, or servers not pictured in FIG. 3 so as to not obscure the focus on the present disclosure.

The network environment 300 comprises one or more access management devices (AMDs), such as the AMD 312 (e.g., the AMD 212 of FIG. 2). The AMD 312 may include any one or more aspects described with respect to the AMD 212 of FIG. 2. The AMD 212 is configured to wirelessly communicate with various UEs, such as the first UE 202 and/or the second UE 204, via one or more protocols described with respect to FIG. 2. The AMD 312 may communicate and/or receive signals to and/or from the first UE 302 and/or the second UE 304 via one or more transmissions 305. In response to receiving certain requests from the first UE 302 and/or the second UE 304, the AMD 212 may communicate with the non-terrestrial node 310. The non-terrestrial node 310 may send a response to the requests to the AMD 312, and the AMD 312 may communicate the response to the first UE 302 and/or the second UE 304. The AMD 312 may be associated with a home area (e.g., a registered address of the AMD 312 and/or a HI subscription plan associated with the AMD 312 and/or a threshold distance from the registered address of the AMD 312), as described with respect to FIG. 2.

The network environment 300 includes a gateway 314 communicatively connected to the NTN 318 and the non-terrestrial node 310. The gateway 314 may be connected to the NTN 318 via one or more wireless or wired connections and is connected to the non-terrestrial node 310 via a feeder link 320. The gateway 314 may take the form of a device or a system of components configured to communicate with the AMD 312 via the non-terrestrial node 310 and to provide an interface between the NTN 318 and the non-terrestrial node 310. Generally, the gateway 314 utilizes one or more antennas to transmit signals to the non-terrestrial node 310 via a forward uplink 316 and to receive signals from the non-terrestrial node 310 via a return downlink 317 (the feeder link 320). The gateway 314 may communicate with a plurality of non-terrestrial nodes, including the non-terrestrial node 310.

The network environment 300 includes one or more non-terrestrial nodes, represented by the non-terrestrial node 310. The non-terrestrial node 310 may take various forms (e.g., satellites, drones, aircrafts, high altitude platforms, and the like). The non-terrestrial node 310 is generally configured to relay communications between the gateway 314 and one or more UEs, such as the first UE 302 and/or the second UE 304, such as via the AMD 312. The non-terrestrial node 310 communicates with the gateway 314 using the feeder link 320 and communicates with the AMD 312 using a user link 322. The user link 322 comprises a forward downlink 306 used to communicate signals from the non-terrestrial node 310 to the AMD 312 and a return uplink 308 used to communicate signals from the AMD 312 to the non-terrestrial node 310. The non-terrestrial node 310 may communicate with the first UE 302 and/or the second UE 304 via the AMD 312 using any wireless telecommunication protocol desired by a network operator, including but not limited to 3G, 4G, 5G, 6G, 802.11x and the like. Though shown as having a single beam providing coverage to a non-terrestrial coverage area 324, the non-terrestrial node 310 may be configured to utilize a plurality of individual beams to communicate with multiple different areas at or near the same time. Similarly, though a single forward downlink 306 and a single return uplink 308 are illustrated, the AMD 312 may utilize multiple downlinks and/or multiple uplinks to communicate with the non-terrestrial node 310, using any one or more frequencies as desired by a network operator.

The network environment 300 includes one or more NTNs, represented by the NTN 318. The NTN 318 comprises any one or more public or private networks. The NTN 318 may be configured according to one or more network architectures and/or principles, such as conventional RAN, cloud-based RAN, and/or open RAN technologies. In some aspects, the NTN 318 may be configured as a satellite network connecting to a plurality of gateways, such as the gateway 314. One or more UEs, such as the first UE 302 and/or the second UE 304 may communicate with the NTN 318 via the AMD 312, which may communicate with the non-terrestrial node 310, which may communicate with the gateway 314, which may communicate with the NTN 318.

The NTN 318 may comprise any one or more computer processing components (e.g., network functions (NFs)) that perform any one or more functions described with respect to FIG. 2. For example, functions performed by the location NF 220, the controller NF 222, the policy NF 224, the session NF 226, and the metering NF 228 of FIG. 2 may be performed by one or more computer processing components of the NTN 318. In aspects, the one or more computer processing components of the NTN 318 may be the same as the NFs of the core network 218 described with respect to FIG. 2. In aspects, the one or more computer processing components may instead take other forms but perform the same functions as the NFs of the core network 218 described with respect to FIG. 2. In aspects, a portion of the one or more computer processing components are the same as the NFs of the core network 218 of FIG. 2 and a portion of the one or more computer processing components take different forms but perform at least some of the functions performed by the one or more NFs of the core network 218 of FIG. 2.

Relevant to the present disclosure, the core network 218 of FIG. 2 and/or the NTN 318 of FIG. 3 may be configured to allow the AMD 212 and/or the AMD 312 to utilize network resources based on a duration of time the AMD 212 and/or the AMD 312 accesses network resources. Conventional HI subscription plans typically require the AMD 212 and/or the AMD 312 be located at an address registered with the AMD 212 and/or the AMD 312 (or within a threshold distance from the address registered with the AMD 212 and/or the AMD 312) in order for UEs (e.g., the first UE 202 and/or the second UE 204 of FIG. 2, the first UE 302 and/or the second UE 304 of FIG. 3) to access HI. Further, conventional HI plans typically only provide data of a particular volume over a certain time period (e.g., 5MB a month). However, by initiating and/or enabling timer-based metering of network resources, a more flexible approach to HI is provided.

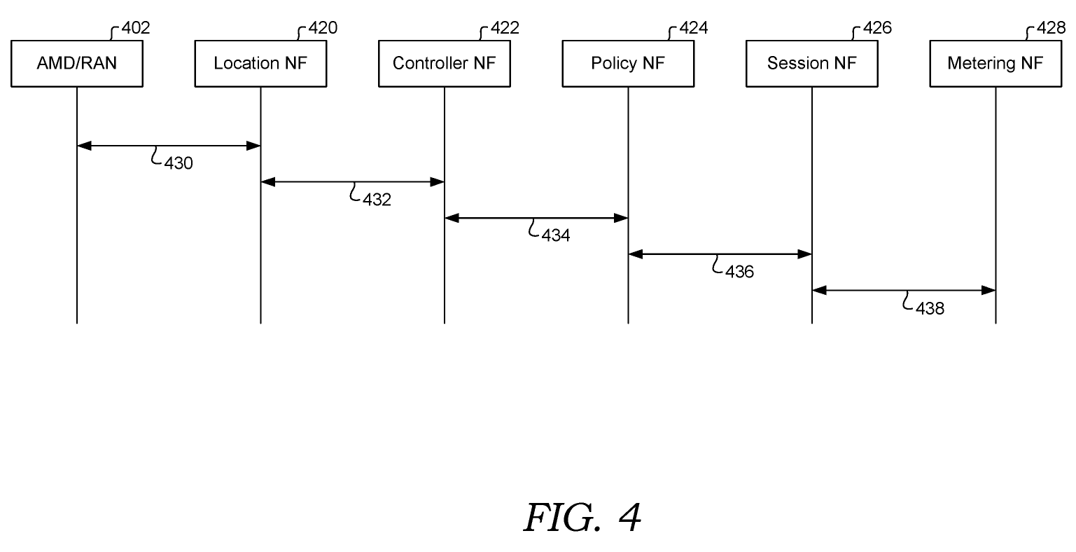

Turning now to FIG. 4, call flow diagram is illustrated in accordance with one or more aspects of the present disclosure. A call flow 400 may be performed by and/or facilitated by one or more NFs, one or more computer processing components, and/or a combination of these, as discussed in greater detail herein, and is not meant to exhaustively show every interaction that would be necessary to practice the invention, so as not to obscure the present disclosure. The call flow 400 may generally involve an access management device (AMD) (e.g. the AMD 212 of FIG. 2, the AMD 312 of FIG. 3) connected to a radio access network (RAN) (AMD/RAN) 412 (e.g., via a base station, such as the base station 210 of FIG. 2, via the non-terrestrial node 310 and/or the gateway 314 of FIG. 3). The call flow 400 includes a location NF 420 (e.g., the location NF 220 of FIG. 2), a controller NF 422 (e.g., the controller NF 222 of FIG. 2), a policy NF 424 (e.g., the policy NF 224 of FIG. 2), a session NF 426 (e.g., the session NF 226 of FIG. 2), and a metering NF 428 (e.g., the metering NF 228 of FIG. 2). While described as NFs in FIG. 4, it is expressly contemplated that any one or more computer processing components may perform the functions of any one or more of the NFs described with respect to the call flow 400. The call flow 400 may include one or more aspects described with respect to FIGS. 2-3. Each of the preceding NFs may take different forms (e.g., computer processing components), including consolidated or distributed forms that perform the same general operations. In other architectures or protocols, the NFs may be given other names, however, the NFs herein refer to functions, not specifically identified components.

At a first step 430, the location NF 420 receives an indication to initiate timer-based metering of network resources consumed by the AMD (e.g., the AMD of the AMD/RAN 412). In some aspects, the AMD communicates the indication to the location NF 420, and in other aspects, one or more other NFs communicate the indication to the location NF 420. In aspects, the indication may take the form of a communication causing initiation of timer-based metering of network resources consumed by the AMD.

In some aspects, such as the aspects shown in the call flow 400, the indication is caused by the AMD communicating a location to the location NF 420, such as within an attach request to the network. The location of the AMD may include a cell ID, enhanced cell ID, latitude and longitude, global positioning system (GPS), Wi-Fi positioning system (WPS), time of arrival, and the like. In aspects, the location NF 420 may access location information associated with the AMD, such as its location (e.g., the location communicated to the location NF 420), as well as a home area associated with the AMD. The home area may include an address associated with the AMD, and may include a threshold distance from the address that is included in the home area. In aspects, the indication is generated by the location NF 420 determining the AMD is located outside of (e.g., a threshold distance away from) a home area associated with the AMD (e.g., the AMD of the AMD/RAN 412). For example, the AMD may communicate a location that is 30 miles away from the home area of the AMD, triggering the initiation of timer-based metering of network resources. In such aspects, the location NF 420 determining the AMD is located outside of the home area of the AMD may act as the indication to initiate timer-based metering of network resources.

In some aspects, an automated subscriber control (ASC) system communicates the indication to the location NF 420 indicating the location of the AMD is outside of the home area of the AMD and to initiate the timer-based metering of network resources. In such aspects, the ASC system may access the location information associated with the AMD and determine the location is outside of the home area of the AMD. In such aspects, the ASC system may add a service option code (SOC) reflecting timer-based metering of network resources to a billing system of the AMD. In some aspects, the addition of the SOC to the billing system of the AMD (e.g., at the metering NF 428) may cause the indication to initiate timer-based metering of network resources to be communicated to the location NF 420. In some aspects, the ASC system is a component of the location NF 420 and/or is in communication with the location NF 420.

In other aspects, at the first step 430, the indication to initiate timer-based metering is communicated manually to the location NF 420. In aspects, the subscriber may access an application associated with an MNO and manually initiate timer-based metering (e.g., the subscriber interacts with an interface of a UE and/or the AMD to start a timer). For example, an application server associated with an MNO application may cause timer-based metering to initiate by communicating the indication to the location NF 420 indicating that timer-based metering should be initiated (e.g., based on the subscriber input into the MNO application). In another example, a subscriber may request an MNO manually initiate timer-based metering. In this example, the MNO may generate and communicate the indication to the location NF 420 to cause timer-based metering to initiate. In either of these examples, the ASC system may add an SOC to a billing system of the AMD which may cause the indication to initiate timer-based metering to be communicated to the location NF 420.

At a second step 332, the location NF 420 communicates an indication to initiate timer-based metering to the controller NF 422. In some aspects, the indication is the same as the indication received in the first step 430, and in other aspects, the location NF 420 modifies the indication prior to communicating the indication to the controller NF 422. For example, the location NF 420 may remove unnecessary information received from the AMD (e.g., the AMD of the AMD/RAN 412), the ASC, and/or other NFs, prior to communicating the indication. In aspects, the indication may take another form that the indication received by the location NF 420 in the first step 430 (e.g., the communication has different content and/or a different format indicating timer-based metering of network resources should be initiated).

At the second step 432, the controller NF 422 receives the indication from the location NF 420. At the second step 432, in some aspects, the controller NF 422 determines whether the AMD (e.g., the AMD of the AMD/RAN 412) is entitled to timer-based metering. In aspects, the controller NF 422 accesses provisioning information associated with the AMD. In aspects, the provisioning information may include whether a subscription associated with the AMD includes timer-based metering of network resources. In some aspects, the provisioning information includes an SOC added to a billing system associated with the AMD indicating the AMD is entitled to timer-based metering of network resources. In aspects, the provisioning information specifies a particular duration of time that the AMD is entitled to utilize network resources (e.g., the AMD has up to 30 hours of utilization). The provisioning information may include other details relevant to the timer-based metering of the network resources (e.g., network speed, volume of data per hour).

At a third step 434, the controller NF 422 communicates the indication to initiate timer-based metering of network resources to the policy NF 424. In some aspects, the indication is the same as the indication received by the controller NF 422 at the second step 432, and in other aspects, the indication is modified by the controller NF 422 prior to communicating the indication to the policy NF 424. For example, the controller NF 422 may determine the AMD (e.g., the AMD of the AMD/RAN 412) is entitled to timer-based metering of network resources and modify the indication to reflect this determination. In another example, the controller NF 422 may modify the indication to include the provisioning information.

At the third step 434, the policy NF 424 receives the indication to initiate timer-based metering of network resources consumed by the AMD (e.g., the AMD of the AMD/RAN 412). The policy NF 424 may, at the third step 434, modify one or more data usage policies associated with the AMD to generate one or more modified data usage policies. As used herein, modify may include modifying existing data usage policies, creating new data usage policies, removing data usage policies, and/or a combination of these. In aspects, the policy NF 424 modifies the one or more data usage policies based on the provisioning information. In aspects, the one or more modified data policies may include a duration of time the AMD is permitted to use network resources and/or a billing rate of the timer-based metering of network resources. For example, the one or more modified data policies may specify the AMD is permitted to utilize network resources for 20 hours, 30 hours, 4 days, 2 weeks, and the like. In some aspects, the billing rate of the timer-based metering is higher or lower than a billing rate associated with home use of the AMD. For example, the billing rate for a first network speed using home internet may be lower in cost than the billing rate for the first network speed using network resources away from home (using timer-based metering of network resources). The one or more modified data usage policies may instruct and/or enable one or more NFs to generate a timer to monitor and/or track the duration of time the AMD is permitted to use the network resources. In aspects, the one or more modified data usage policies may be communicated to one or more NFs to implement and/or effectuate the indication to initiate timer-based metering of network resources, such as to the session NF 426.

At a fourth step 436, the policy NF 424 communicates the one or more modified data usage policies to the session NF 426. At the fourth step 436, the session NF 426 receives the one or more modified data usage policies. In aspects, the one or more modified data usage policies may act as the indication to the session NF 426 to initiate timer-based metering of network resources. In some aspects, the one or more modified data usage policies may be communicated to the session NF 426 upon the session NF 426 requesting data usage policies associated with the AMD (e.g., the AMD of the AMD/RAN 412) (e.g., the session NF 426 requests the data usage policies when establishing a session between the network and the AMD). At the fourth step 436, the session NF 426 may receive the one or more modified data usage policies and initiate timer-based metering of network resources. The one or more modified data usage policies may include instructions the session NF 426 may implement (e.g., at the session NF 426, at the metering NF 428). For example, the one or more modified data usage policies may instruct the session NF 426 to configure the metering NF 428 to establish a timer for the AMD such that the metering NF 428 can monitor and/or track the duration of time the AMD utilizes network resources. In another example, the one or more modified data usage policies may reflect the AMD’s entitlement to timer-based metering of network resources. In aspects, the one or more modified data usage policies may reflect specific attributes of the timer-based metering (e.g., network speeds, volume of data per unit of time, a network resources usage tracking method).

At a fifth step 438, the session NF 426 implements the one or more modified data usage policies by coordinating with and/or communicating with the metering NF 428. The session NF 426 may coordinate with the metering NF 428 to initiate and enable timer-based metering of network resources. In some aspects, the session NF 426 communicates one or more instructions to the metering NF 428. The one or more instructions may instruct the metering NF 428 to establish a timer associated with the AMD (e.g., the AMD of the AMD/RAN 412). In some aspects, when the timer is running (e.g., after the timer is started), the AMD is permitted to utilize network resources, and when the timer is stopped, the AMD is prohibited from utilizing network resources. In other aspects, the timer automatically starts when the AMD utilizes network resources, and the timer stops when the AMD ceases to utilize network resources (e.g., the AMD is turned off, the AMD is no longer connected to the network).

The timer of the metering NF 428 may be controlled in various ways. In some aspects, a subscriber associated with the AMD (e.g., the AMD of the AMD/RAN 412) may interact with an application in communication with the metering NF 428 (e.g., the application server associated with the application communicates with the metering NF 428). In aspects, the subscriber provides subscriber input into the application causing the timer of the metering NF 428 to start or stop. In other aspects, the timer of the metering NF 428 may automatically be started when the AMD utilizes network resources and automatically stopped when the AMD ceases utilizing network resources (e.g., the timer begins running when the AMD connects to the network and stops when the AMD is not connected to the network). In aspects, the timer of the metering NF 428 may start once the timer-based metering of network resources is enabled and stop when the AMD communicates a location within the home area of the AMD to the network (e.g., to the location NF 420).

In aspects, the metering NF 428 monitors and/or tracks the duration of time the AMD utilizes network resources (e.g., using the timer). In aspects, the duration of time the AMD utilizes network resources comprises a total duration of time the AMD utilizes the network resources, with no regard to the number of devices utilizing the AMD. For example, a first device utilizes network resources via the AMD for 3 hours, a second UE also utilizes for 3 hours via the AMD at the same time as the first UE. In this example, the duration is 3 hours even though the two devices utilized network resources 6 hours in total. In other aspects, the duration of time the AMD utilizes network resources comprises a total duration of time each device connected to the AMD utilizes the network resources. For example, a first UE utilizes network resources for 4 hours via the AMD, a second UE utilizes 2 hours via the AMD. In this example, the duration is 6 hours of utilization of network resources even though the first UE and the second UE may utilize the network resources at the same time.

The session NF 426 may instruct the metering NF 428 to notify one or more NFs when an allotted duration of time the AMD is permitted to use network resources is reached (e.g., the timer monitoring and/or tracking the duration of time the AMD utilizes network resources reaches the allotted duration of time the AMD is permitted to use the network resources). In aspects, the metering NF 428 may notify one or more NFs that the allotted duration of time is reached. In aspects, one or more of the session NF 426, the policy NF 424, the controller NF 422, and/or the location NF 420 may communicate with the metering NF 428 to terminate the timer-based metering of network resources. In some aspects, the metering NF 428 may notify the session NF 426 that the allotted duration of time is reached, and the session NF 426 may notify the policy NF 424 to alter the one or more modified data usage policies to reflect termination of the timer-based metering of network resources (e.g., the policy NF 424 modifies the one or more modified data usage policies to indicate the AMD is not entitled to timer-based metering of network resources). In aspects, the metering NF 428 may be initially configured (e.g., by the session NF during the fifth step 438) to cease timer-based metering of network resources once the allotted duration of time is reached and/or expires.

In some aspects, when the one or more NFs are notified the allotted duration of time the AMD is permitted to use network resources is reached, the one or more NFs may cause a subscriber to receive an upsell page to purchase a pass for an additional duration of timer-based metering of network resources (e.g., an additional 2 days of network resources) and/or a plan with a different billing structure than described. For example, the subscriber might be presented with an upsell page on one or more devices (e.g., the first UE 202 and/or the second UE 204 of FIG. 2, the first UE 302 and/or the second UE 304 of FIG. 3) that allows the subscriber to select additional resources and/or consent to a higher billing rate. In some aspects, the subscriber may be permitted to continue accessing the network resources beyond the expiration of the allotted duration of time the AMD is permitted to use resources. In such aspects, the network speed associated with the AMD may be throttled such that the AMD accesses the network resources at a lower network speed. In such aspects, the subscriber may be directed to an upsell page to select a higher network speed.

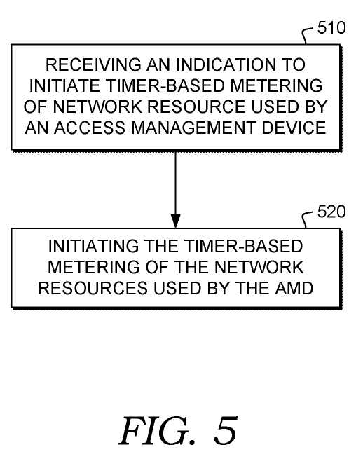

Turning now to FIG. 5, a flow chart is provided that illustrates one or more aspects of the present disclosure relating to a method 500 for enabling timer-based metering within a network. The method 500 may include one or more aspects described with respect to FIGS. 2-4.

At a first step 510, an NF (as described with respect to FIG. 2) and/or a computer processing component (as described with respect to FIG. 3) (e.g., performing one or more functions of the NFs described with respect to FIG. 2/FIG. 4) receives an indication to initiate timer-based metering of network resources utilized by an access management device (AMD) (e.g., the AMD 212 of FIG. 2, the AMD 312 of FIG. 3, the AMD of the AMD/RAN 412 of FIG. 4). In aspects, the NF is a location NF (e.g., the location NF 220 of FIG. 2, the location NF 420 of FIG. 4), and the indication is received from the AMD (e.g., via a base station, via a non-terrestrial node and/or a gateway). In some of such aspects, the indication reflects a location of the AMD being outside of a home area of the AMD, as described with respect to FIG. 2-4. In aspects, the NF is a controller NF (e.g., the controller NF 222 of FIG. 2, the controller NF 422 of FIG. 4), and the indication is received from a location NF (e.g., the location NF 220 of FIG. 2, the location NF 420 of FIG. 4). In aspects, the NF is a policy NF (e.g., the policy NF 224 of FIG. 2, the policy NF 424 of FIG. 4), and the indication is received from a controller NF (e.g., the controller NF 222 of FIG. 2, the controller NF 422 of FIG. 4). In aspects, the NF is a session NF (e.g., the session NF 226 of FIG. 2, the session NF 426 of FIG. 4), and the indication takes the form of one or more modified data usage policies associated with the AMD and may reflect the AMD’s entitlement to timer-based metering of network resources. In aspects, the NF is a metering NF (e.g., the metering NF 228 of FIG. 2, the metering NF 428 of FIG. 4), and the indication takes the form of one or more instructions instructing the metering NF to establish timer-based metering of network resources, and the indication may be received from a session NF (e.g., the session NF 226 of FIG. 2, the session NF 426 of FIG. 4), as described with respect to FIG. 4.

At a second step 520, an NF (e.g., a location NF, a controller NF, a policy NF, a session NF, a metering NF) and/or a computer processing component (e.g., performing one or more functions of the NFs of FIG. 2/FIG. 4) causes initiation of the timer-based metering of the network resources utilized by the AMD. In aspects, the NF is a location NF, and the location NF causes the initiation of timer-based metering of the network resources by communicating the indication to initiate the timer-based metering to a controller NF. In aspects, the NF is a controller NF, and the controller NF causes the initiation by determining the AMD is entitled to timer-based metering and communicating this determination to a policy NF. In aspects, the NF is a policy NF, and the policy NF causes the initiation by modifying one or more data usage policies to generate one or more modified data usage policies reflecting the AMD’s entitlement to timer-based metering. In such aspects, the one or more modified data usage policies may be implemented to initiate the timer-based metering of network resources. In aspects, the NF is a session NF, and the session NF causes the initiation by implementing one or more modified data usage policies instructing initiation of timer-based metering (e.g., the session NF coordinates with a metering NF to implement the one or more modified data usage policies). In aspects, the NF is a metering NF, and the metering NF causes initiation and/or enablement of the timer-based metering by receiving and/or implementing instructions from a session NF (e.g., establishing a timer to monitor and/or track a duration of time the AMD utilizes network resources), as described with respect to FIG. 4.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for enabling timer-based metering within a network, the method comprising:
receiving, at a policy network function (NF), an indication to initiate timer-based metering of network resources utilized by an access management device (AMD);
initiating, by the policy NF, the timer-based metering of the network resources utilized by the AMD by modifying one or more data usage policies associated with the AMD; and
communicating, by the policy NF, one or more modified data usage policies associated with the AMD to a session NF.

2. The method of claim 1, further comprising:
causing, by the session NF, the timer-based metering of the network resources to occur by communicating with a metering NF.

3. The method of claim 2, further comprising monitoring, by the metering NF, a duration of time the AMD utilizes the network resources.

4. The method of claim 3, wherein the metering NF is configured to start and stop a timer associated with the timer-based metering of the network resources, wherein the AMD utilizes the network resources when the timer is running, and wherein the AMD is prohibited from utilizing the network resources with the timer is stopped.

5. The method of claim 4, wherein the start and the stop of the timer is determined by subscriber input into an application.

6. The method of claim 1, wherein the indication to initiate the timer-based metering of the network resources utilized by the AMD is generated by a location NF based on location information associated with the AMD, wherein the location information indicates the AMD is located outside of a home area associated with the AMD.

7. The method of claim 1, wherein the AMD is associated with a subscription plan entitling the AMD to the timer-based metering of the network resources utilized by the AMD.

8. The method of claim 3, wherein the policy NF is a policy and control function (PCF), wherein the session NF is a session management function (SMF), and wherein the metering NF is a charging function (CHF).

9. A method for enabling timer-based metering within a network, the method comprising:
receiving, at a session network function (NF), an indication to initiate timer-based metering of network resources utilized by an access management device (AMD); and
initiating, by the session NF, the timer-based metering of the network resources utilized by the AMD by communicating with a metering NF.

10. The method of claim 9, further comprising monitoring, by the metering NF, a duration of time that the AMD utilizes the network resources.

11. The method of claim 9, wherein the indication comprises one or more modified data usage policies, wherein one or more data usage policies are modified by a policy NF to generate the one or more modified data usage policies enabling the timer-based metering of the network resources utilized by the AMD.

12. The method of claim 9, wherein communicating with the metering NF comprises the session NF implementing one or more modified data usage policies received from a policy NF.

13. The method of claim 9, wherein the indication is communicated by a policy NF to the session NF.

14. The method of claim 9, wherein the session NF is a session management function (SMF) and wherein the metering NF is a charging function (CHF).

15. A method for enabling timer-based metering within a network, the method comprising:
receiving, at a location NF, location information associated with an access management device (AMD); and
communicating, by the location NF, an indication to initiate timer-based metering of network resources utilized by the AMD to one or more NFs, wherein communicating the indication causes the timer-based metering of network resources utilized by the AMD to initiate.

16. The method of claim 15, wherein the location information indicates the AMD is located outside of a home area associated with the AMD.

17. The method of claim 16, wherein determining the AMD is located outside of the home area associated with the AMD causes the indication to be communicated by the location NF to the one or more NFs.

18. The method of claim 17, wherein the location NF communicates the indication to a controller NF, and wherein the controller NF determines the AMD is entitled to timer-based metering of the network resources utilized by the AMD based on provisioning information.

19. The method of claim 18, wherein the provisioning information indicates the AMD is associated with a subscription plan including the timer-based metering of the network resources.

20. The method of claim 19, wherein the controller NF communicates that the AMD is entitled to the timer-based metering of the network resources utilized by the AMD to a policy NF, wherein the policy NF modifies one or more data usage policies to generate one or more modified data usage policies enabling the timer-based metering of the network resources utilized by the AMD.
